(19) United States
(12) Patent Application Publication
(10) Pub. No.: US 2012/0110531 A1
(43) Pub. Date: May 3, 2012

(54) DEFECT AND YIELD PREDICTION FOR SEGMENTS OF AN INTEGRATED CIRCUIT

(75) Inventors: Hongmei Liao, San Diego, CA (US); Michael Laisne, Encinitas, CA (US)

(73) Assignee: QUALCOMM INCORPORATED, San Diego, CA (US)

(21) Appl. No.: 12/914,849

(22) Filed: Oct. 28, 2010

(51) Int. Cl. G06F 17/50

(52) U.S. Cl. 716/112

(57) ABSTRACT

Defect prediction information is determined for a segment of an integrated circuit layout. Marker information is obtained, for example from user input into a computer design tool, where the marker information defines the segment. A segment can be defined to be any arbitrary portion of the layout and can include portions of multiple blocks. The marker information is used to extract layout information corresponding to the segment. The extracted segment layout information is analyzed to determine the defect prediction information. In one example, the determination involves performing a Critical Area Analysis such that the defect prediction information is a yield prediction value. This process is repeated for multiple segments, and the defect prediction information for the segments is compared to identify the segment most susceptible to defects. The user can modify the design of the segment, and repeat the process to improve yield in the manufacture of the integrated circuit.

### BACKGROUND INFORMATION

1. Technical Field

The disclosed embodiments relate to predicting defects and/or to predicting yields in the manufacture of integrated circuits.

2. Background Information

When integrated circuits are manufactured, some of them are defective. The defective integrated circuits must generally be discarded and as a result the cost of producing the remaining functional integrated circuits increases. The percentage of such functional integrated circuits to the total number of integrated circuits manufactured is commonly referred to as yield. A high yield is desired. Several techniques are used to predict yield of a given layout of an integrated circuit. By using such yield prediction techniques, various alternative layouts of the integrated circuit can be analyzed and compared to determine which layout will result in the highest yield when the integrated circuit is ultimately fabricated.

One method for predicting yield involves performing a Critical Area Analysis (CAA). By performing a CAA on different areas of the circuit layout before fabrication, the areas particularly susceptible to failures due to random particles can be identified. As a result of such identification, these areas can be redesigned to decrease the critical area thereby improving yield when the integrated circuit is fabricated.

FIG. 1 (Prior Art) is a flowchart of a conventional method 1 of performing a CAA in order to improve the yield. In a first step 2, circuit layout information for an integrated circuit is provided as an input into a system performing the analysis. The circuit layout information is commonly in the form of a Graphic Data System (GDS) II file. In a second step 3, the system performs a CAA on a cell(s) of the integrated circuit, on a block(s) of the integrated circuit, or on the entire integrated circuit. In a third step 4, results of the CAA are analyzed. In a fourth step 5, the design is modified and re-analyzed, or the design is prepared for fabrication. If the results of the CAA are adequately favorable, then the design of the integrated circuit may be deemed appropriate for fabrication. Otherwise, modifications may be made to areas of the circuit identified by the CAA as being most susceptible to failure. After making the appropriate modifications to the circuit layout, the four steps 2-5 are repeated for the new circuit layout. By repeating the process of steps 2-5 and redesigning defect-susceptible portions of the integrated circuit appropriately, the yield of the manufactured integrated circuit can be improved.

### SUMMARY

Defect prediction information is determined for a segment of an integrated circuit layout. Marker information is obtained, for example from user input into a computer design tool, where the marker information obtained defines the segment. A segment can be defined in this way to be any arbitrary portion of the integrated circuit layout. A segment can be defined to include portions of multiple blocks. The marker information once obtained is then used to extract segment layout information corresponding to the segment. The extracted segment layout information is analyzed to determine the defect prediction information for the segment.

In one example, the defect prediction information for the segment is a yield prediction value. In this example, the determination involves performing a Critical Area Analysis (CAA) to obtain a Critical Area Analysis Index Value (CAAIV) for the segment, and this CAAIV is used to obtain the yield prediction value. This process of determining a yield prediction value for a segment is repeated for multiple segments, and the resulting defect prediction values for the segments are compared to identify the segment most susceptible to defects. The user can modify the design of the most susceptible segment, and can repeat the process multiple times to improve yield in the manufacture of the integrated circuit.

In one example, a computer design tool includes a computer and a display. The tool obtains marker information from a user. A text box is presented to the user on the display of the computer design tool. The user enters the name of a net into the text box. From the net name, the computer design tool determines marker information, where the marker information is a set of coordinates representing segment layout information corresponding to the net identified by the net name. This process is repeated for multiple nets such that marker information is determined for each net. The computer design tool then uses the marker information to extract segment layout information from the integrated circuit layout for each of the various segments. From the extracted segment layout information, the computer design tool determines defect prediction information for the various segments. This defect prediction information is displayed to the user. The computer design tool also compares the defect prediction information for the various segments, identifies the segment most susceptible to defects, and communicates the identified segment to the user. Software for carrying out the method described above can be provided to users on a computer-readable medium or may be communicated to the user electronically such that the user can then load the software onto a computer system and carry out the method. In some examples, the software is part of a suite of integrated circuit design, simulation, layout and mask synthesis tools.

The foregoing is a summary and thus contains, by necessity, simplifications, generalizations and omissions of detail; consequently, those skilled in the art will appreciate that the summary is illustrative only and does not purport to be limiting in any way. Other aspects, inventive features, and advantages of the devices and/or processes described herein, as defined solely by the claims, will become apparent in the non-limiting detailed description set forth herein.

### BRIEF DESCRIPTION OF THE DRAWINGS

FIG. 1 (Prior Art) is a flowchart of a conventional method for modifying the design of an integrated circuit to improve yield in the manufacturing of the integrated circuit.

FIG. 2 is a simplified high-level diagram of a circuit layout 100 of an integrated circuit. The diagram shows four nets where some of the nets extend into multiple blocks.

FIG. 3 is a diagram of the circuit layout 100 of FIG. 2 wherein the circuit layout is in the form of a GDS II file.

FIG. 4 is a diagram of a system usable to enter marker information for a segment, to use the marker information to extract segment layout information from the circuit layout, and to determine therefrom defect prediction information for the segment.

FIG. 5 is a diagram showing how the marker information is used to extract segment layout information for one segment from three layers of the circuit layout information.

FIG. 6 is a diagram that shows how a particle can cause a short defect between two conductors if the center of the particle is within a short critical area.

FIG. 7 is a diagram showing a particle that does not cause a short defect.

FIG. 8 is a diagram that shows how a particle can cause an open defect in a conductor because the center of the particle is within an open critical area.

FIG. 9 is a diagram showing a particle that does not cause an open defect.

FIG. 10 is a table of CAAIV results for each layer of one segment, SEG A.

FIG. 11 shows an equation usable to generate a yield prediction value from a CAAIV value.

FIG. 12 is a table that shows defect prediction information (a yield prediction value) for each layer of the one segment, SEG A.

FIG. 13 is a diagram that illustrates the results of entering marker information into the system of FIG. 4, where marker information for each of four segments has been entered.

FIG. 14 is a diagram that illustrates extracting segment layout information from three layers of the circuit layout using marker information for each of the three more segments, SEG B, SEG C, and SEG D.

FIG. 15 is a table showing the results of analyzing segment layout information for each layer of each of the four segments SEG A, SEG B, SEG C, and SEG D.

FIG. 16 is a table that shows the determined defect prediction information for each of the four segments SEG A, SEG B, SEG C, and SEG D.

FIG. 17 is a table that compares the defect prediction information for all the four segments that were analyzed. The result of the comparison is an identification of the segment that is most susceptible to defects.

FIG. 18 is a flowchart of a method in accordance with one novel aspect.

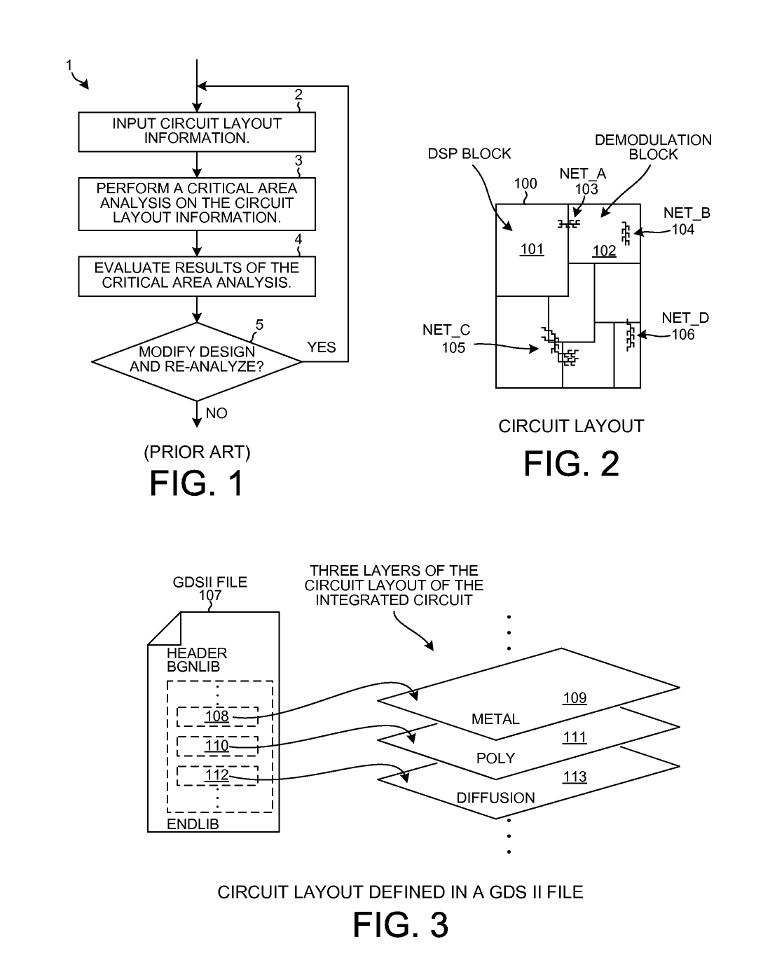

### DETAILED DESCRIPTION

FIG. 2 is a simplified high-level diagram of a circuit layout 100 of an integrated circuit device. In this example, circuit layout 100 includes a Digital Signal Processing (DSP) block 101 and a demodulation block 102, among other blocks that represent functional blocks of the device. The DSP block 101 represents circuit layout information for fabricating circuitry that performs the digital processing functions required by the device, and the demodulation block 102 represents circuit layout information for fabricating circuitry that performs demodulation functions as required by the device. Circuit layout 100 also includes four nets: NET_A 103, NET_B 104, NET_C 105, and NET_D 106. Each net represents a conductive path through circuitry in circuit layout 100. A net may include circuitry within a single block, such as NET_B 104, or may include circuitry from multiple blocks. NET_A 103, for example, extends into block 101 and also extends into block 102.

FIG. 3 is a diagram of circuit layout 100 represented by information in a Graphic Data System (GDS) II file 107. GDS II file 107 includes circuit layout information for each layer of the circuit. Layout information is stored in a particular format and syntax such that the GDS II file 100 can be interpreted by a system involved in the manufacture of the device. In this specific example, GDS II file 107 begins with “HEADER” and “BGNLIB”, and then includes layout information for each layer. In this example, portion 108 is layout information corresponding to a metal layer 109, portion 110 is layout information corresponding to a poly layer 111, and portion 112 is layout information corresponding to a diffusion layer 113. GDS II file 107 represents more or fewer layers depending on the complexity of the integrated circuit device (though only three layers are illustrated to simplify the explanation.)

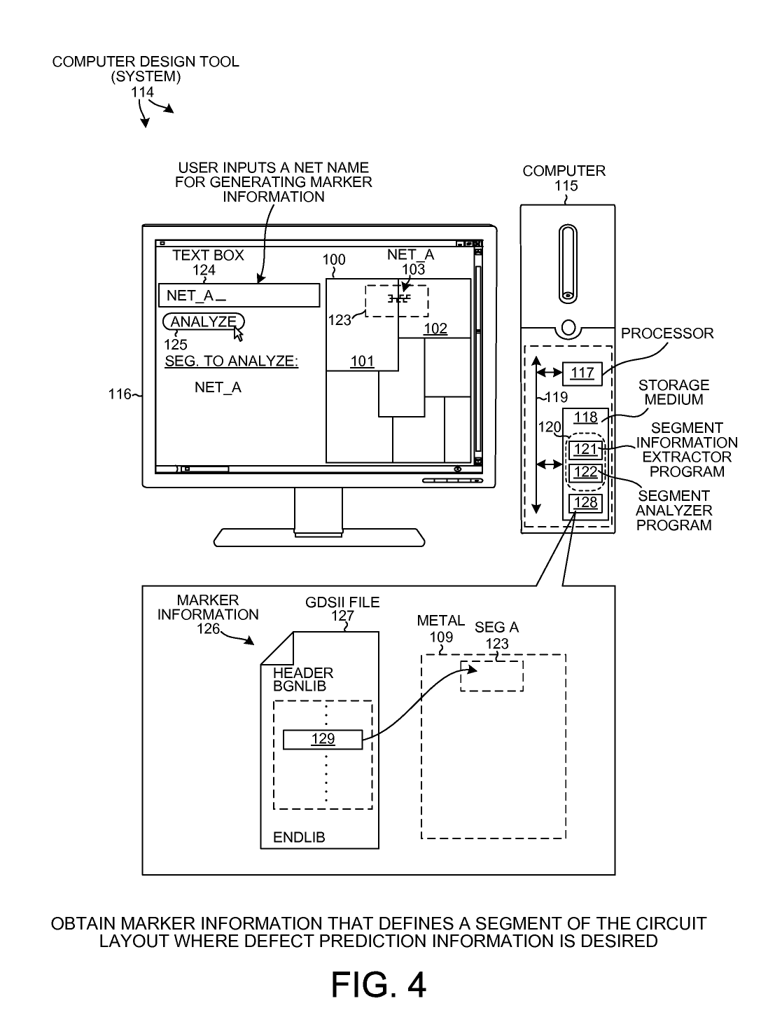

FIG. 4 is a diagram of a computer design tool system 114 usable to determine defect prediction information for a segment of an integrated circuit. System 114 is a computer design tool that includes a computer 115 and a display 116. Computer 115 includes a processor 117 and a storage medium 118. Computer program 120 is stored on storage medium 118. Processor 117 can access storage medium 118 via bus 119 and execute program 120. The computer program 120 further includes a segment information extractor program 121 and a segment analyzer program 122.

In this example, a user of system 114 is interested in obtaining defect prediction information for a segment 123 of the integrated circuit that contains NET_A 103. In this specific example, the marker information is obtained via a system 114. Computer program 120 renders a text box 124 on display 116 for receiving user input. Because the user desires defect prediction information for the segment representing the conductive path of NET_A 103, the user inputs “NET_A” into text box 124 and selects the ANALYZE button 125, thereby notifying program 120 of the user input. Based on the name of the net, program 120 determines a segment that contains NET_A 103. The boundary of the segment is defined by a set of coordinates representing a polygon on each layer of the device. These sets of coordinates are known as marker information. Marker information 126 for the segment 123 is part of a GDS II file 127 stored in a portion 128 of storage medium 118. In the case of NET_A 103 and segment 123, the marker information 126 defines a portion of block 102 and a portion of block 101. For example, portion 129 of GDS II file 127 defines a portion of block 102 and a portion of block 101 on metal layer 109. Accordingly, a segment can extend into multiple blocks and need not contain all of any one block.

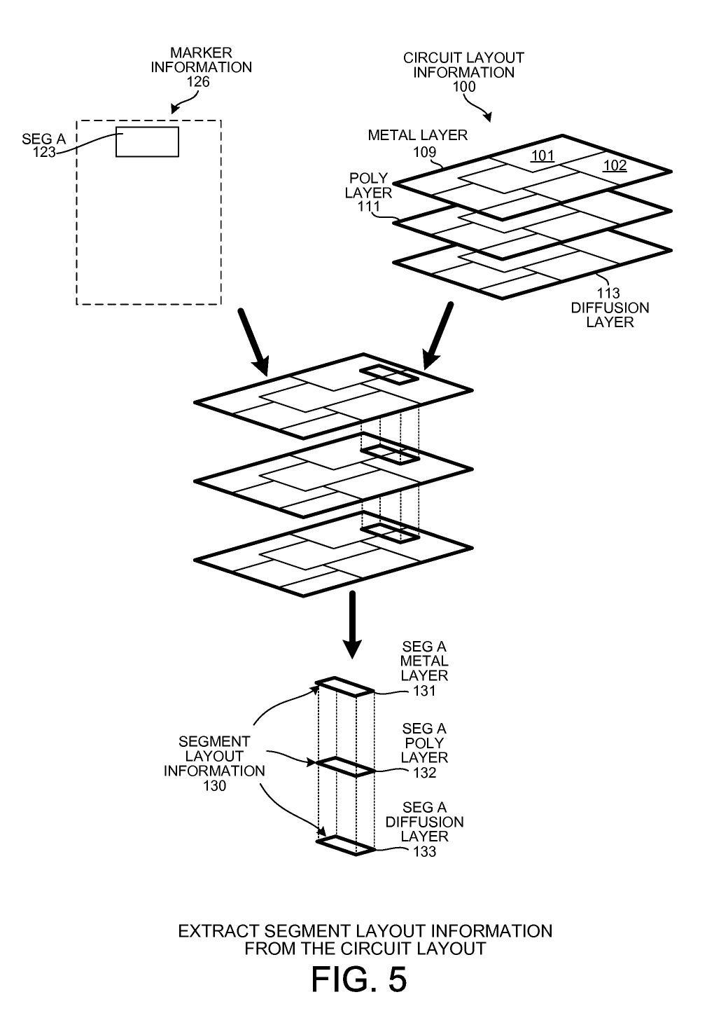

FIG. 5 is a diagram showing a step of extracting segment layout information from the circuit layout 100 of the overall integrated circuit. After marker information 126 has been obtained as a result of user input, segment information extractor program 121 extracts the portion of the circuit layout information 100 that corresponds to SEG A 123 from each layer of the circuit layout 100 of the overall integrated circuit. In this simplified example, the segment 123 corresponding to NET_A 103 involves a polygonal portion of circuit layout information of each of the layers. The polygon representing SEG A 123 is used to extract segment layout information 130 from metal layer 109, poly layer 111, and diffusion layer 113. Segment information extractor program 121 extracts the portion of SEG A metal layer 131, SEG A poly layer 132, and SEG A diffusion layer 133 defined by the polygon defined by the marker information 126.

After the circuit layout information in each layer has been extracted from circuit layout 100, defect prediction information for the identified portion of the layer is determined. In this specific example, a Critical Area Analysis (CAA) is performed by the segment analyzer program 122 on the segment layout information 130 extracted from each layer of the device 100. Performing a CAA on segment layout information 130 results in a critical area. The critical area is the area where the segment is susceptible to random defects for a defined particle size. One objective is to minimize the critical area of the segment in order to minimize the likelihood that the segment will become defective during fabrication due to a random particle. The segment analyzer program 122 determines both a critical area for short defects and a critical area for open defects.

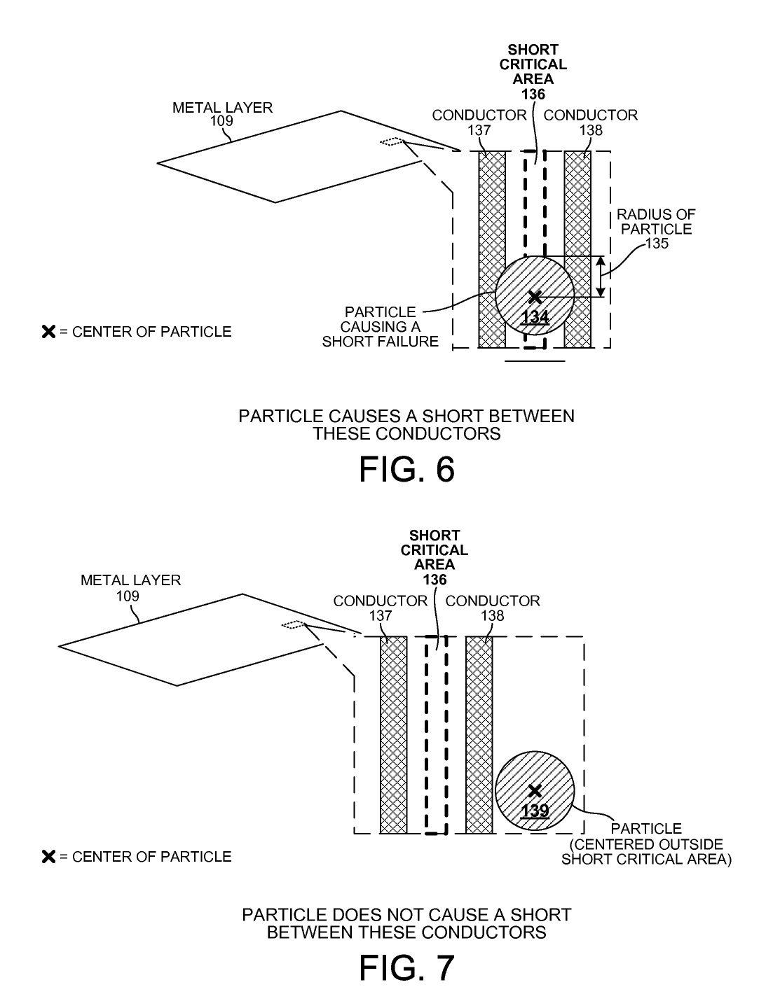

FIG. 6 is a diagram that illustrates a short critical area. Particle 134 has a radius of 135. If the particle 134 of this size has a center located anywhere within short critical area 136, then the particle 134 will extend from conductor 137 to conductor 138 and cause a short defect between conductors 137 and 138. The area 136 within which the center of the particle 134 must be located for such shorting to occur is referred to as the short critical area.

FIG. 7 is a diagram showing a particle that does not cause a short defect. Particle 139 has a center outside of the short critical area 136 and does not short conductors 137 and 138.

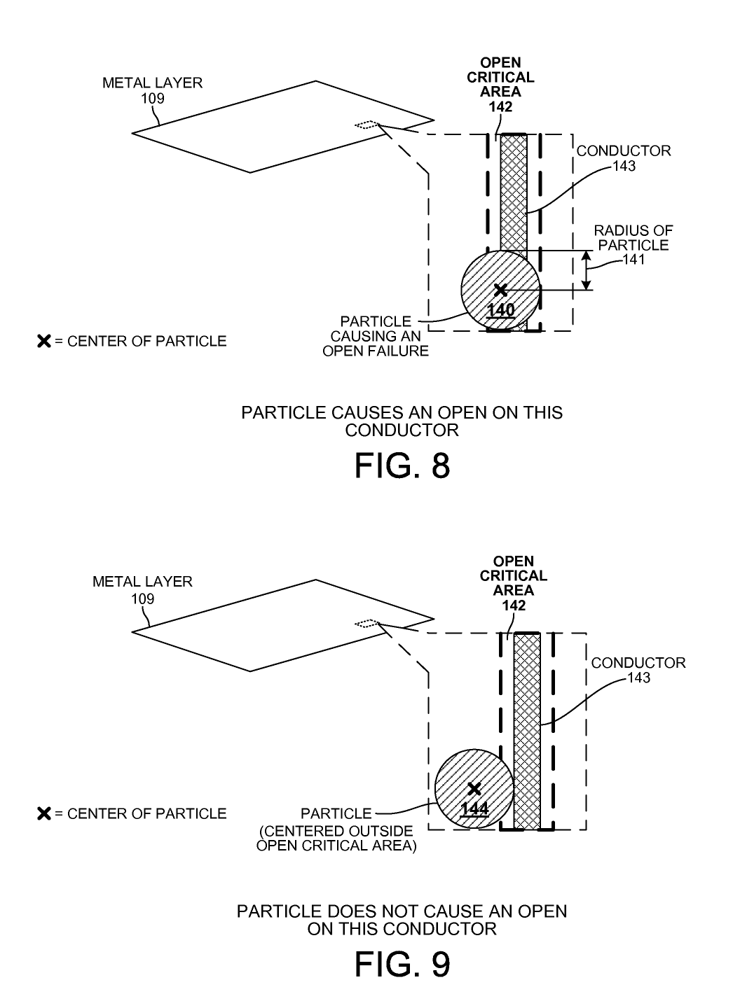

FIG. 8 is a diagram that illustrates an open critical area. Particle 140 has a radius of 141. If the particle 140 of this size has a center located anywhere within this open critical area 142, then the particle 140 will cover conductor 143 and the particle 140 will cause an open defect on conductor 143. The area 142 within which the center of the particle 140 must be located for such an open defect to occur is referred to as the open critical area.

FIG. 9 is a diagram showing a particle that does not cause an open defect. Particle 144 has a center outside of open critical area 142 and does not cause an open defect.

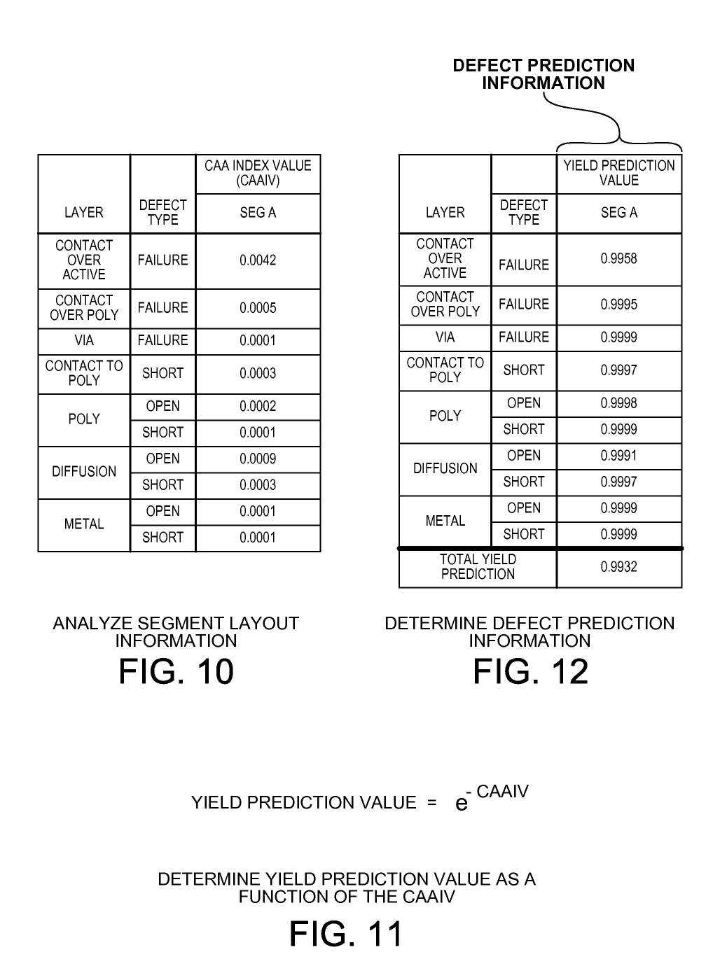

FIG. 10 is a table showing the results of performing a CAA on the segment layout information 130 for each layer of segment SEG A 123. All the resulting CAA values are normalized with respect to each other, thereby obtaining a corresponding set of Critical Area Analysis Index Values (CAAIVs). A CAAIV is a normalized value that takes into account the varying defect distribution sizes and allows for comparison of defect prediction information between segments. A low CAAIV is desired because a larger critical area tends to subject the segment to a higher risk of random particles causing defects during fabrication. The information in the table of FIG. 10 is generated by the computer program 120 and is rendered on display 116 of FIG. 4.

FIG. 11 shows an equation for generating a yield prediction value based on a CAAIV. The yield prediction value is another type of defect prediction information that is determined for each layer of the segment. This technique for determining yield prediction values is referred to as the Poisson distribution model.

FIG. 12 is a table that shows results of determining yield prediction values for each layer of the segment using the equation of FIG. 11. The total yield prediction value in the bottom row is determined by taking the product of each yield prediction value in the column. This table is rendered on display 116 of FIG. 4.

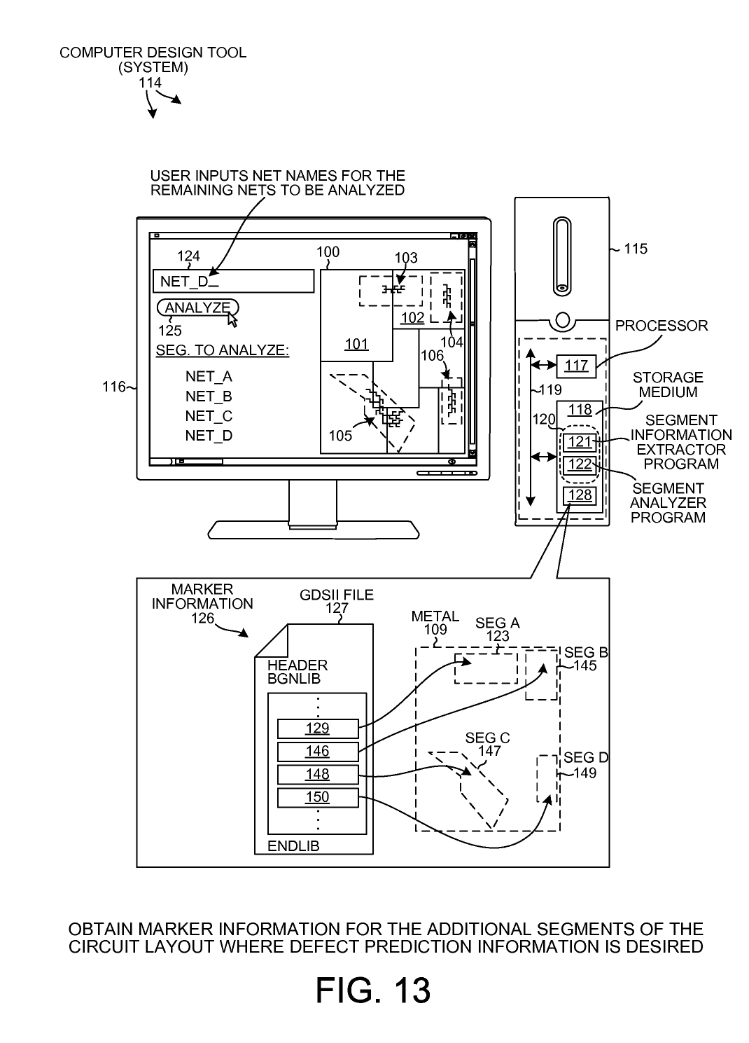

FIG. 13 is a diagram that illustrates obtaining marker information, using the marker information to extract segment layout information, and analyzing the extracted layout information for three more segments 145, 147 and 149. Segment 145 corresponds to and includes NET_B 104. Segment 147 corresponds to and includes NET_C 105. Segment 149 corresponds to and includes NET_D 106. Portions 146, 148, and 150 of GDS II file 127 define portions of metal layer 109 corresponding to segments 145, 147, and 149, respectively. As in FIG. 2, the user enters the net name into text box 124 and selects the analyze button 125 for each additional net to be considered.

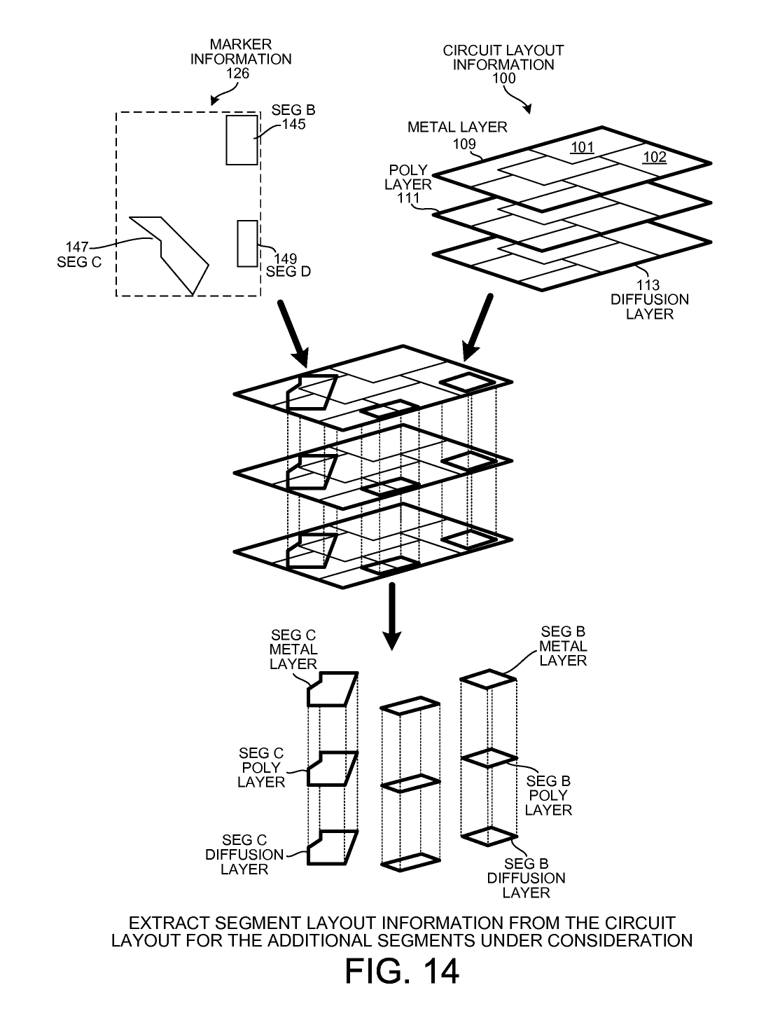

FIG. 14 is a diagram that illustrates the results of extracting segment layout information for the three additional segments 145, 147, and 149.

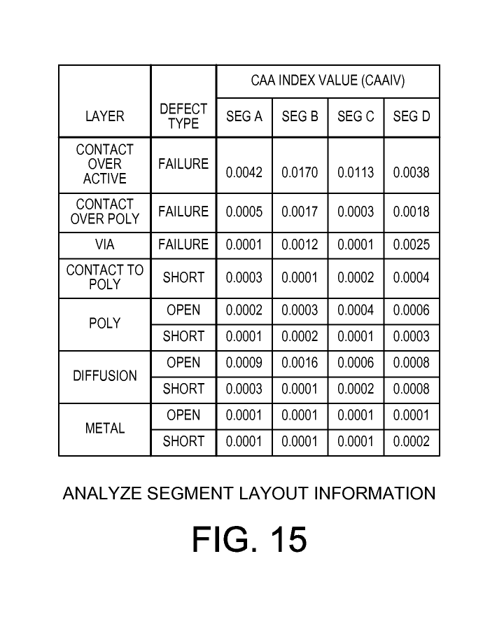

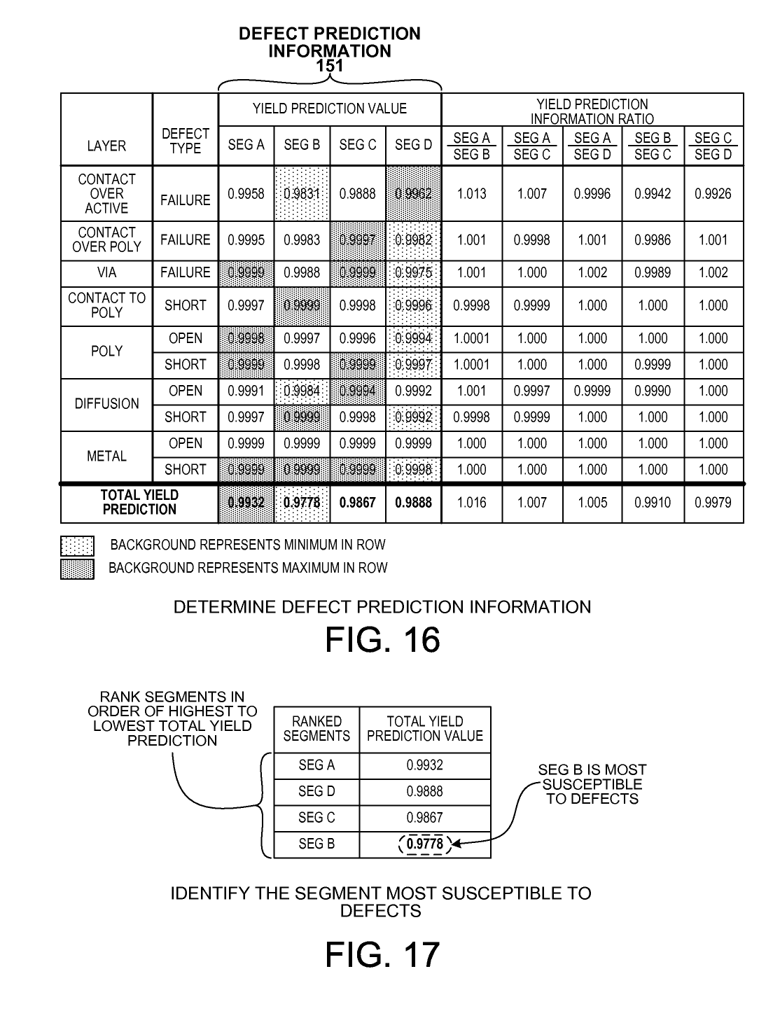

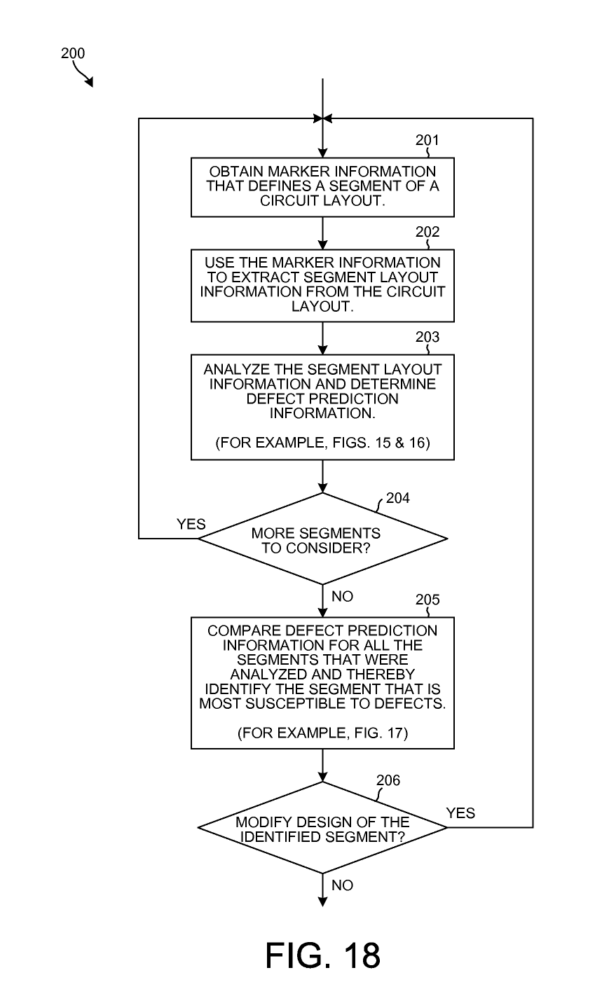

FIG. 15 a table showing the results of analyzing of the segment layout information extracted for each of the three additional segments 145, 147 and 149. The resulting determined CAAIV values for SEG B 145, SEG C 147, and SEG D 149 are appended as columns to the table of FIG. 10. This table is rendered on display 116 of FIG. 4.

FIG. 16 is a table that shows results of determining yield prediction values for the CAAIV values of FIG. 15 for the three additional segments 145, 147 and 149. In this example, defect prediction information is a column of yield prediction values. These yield prediction values are determined using the equation of FIG. 10. The determined yield prediction values for each additional segment are appended as a column to the table of FIG. 12. The result is the table of FIG. 16. The total yield prediction for each segment is determined by computing the product of all the yield prediction values in the column for the segment. The maximum and minimum yield prediction values in each row are highlighted. This table is rendered on display 116 of FIG. 4.

FIG. 17 is a table of the result of comparing defect prediction information 151 for each segment analyzed. The total yield prediction value for each segment is ranked in decreasing order. The lowest value identifies the segment that is most susceptible to defects. In this example, because SEG B 145 has the lowest total yield prediction value, a user may decide to modify the layout of segment SEG B 145 in order to improve yield. This may involve re-routing of conductors in order to increase the space between them and to minimize the effects of random particles. The table of FIG. 17 is rendered on display 116 of FIG. 4.

In another aspect, yield prediction values for each segment are compared by determining the ratio between yield prediction values in different segment layers, as shown in the YIELD PREDICTION INFORMATION RATIO columns of the table in FIG. 16. Comparing the ratios indicates the extremity to which the yield prediction values vary between segments. The ratios also tend to show that SEG B 145 appears to cause the greatest variation in yield prediction information ratios because the ratio of SEG A 123 to SEG B 145 and the ratio of SEG B 145 to SEG C 147 are the ratios that are furthest from 1.00 among the calculated ratios. The table of FIG. 16 is rendered on display 116 of FIG. 4.

FIG. 18 is a flowchart of a method 200 in accordance with one novel aspect. In a first step (step 201), marker information is obtained that defines a segment of a circuit layout. The marker information includes sets of coordinates for a segment. The marker information is obtained by receiving user input. In one example, a user inputs the name of a net or a scan chain of interest, and system 114 generates the marker information for a segment that includes the net or scan chain of interest. For example, in FIG. 4, the user inputs “NET_A” into text box 124 and clicks the analyze button 125. In some cases the marker information defines the same polygonal shape on each layer of the circuit layout, and in other cases the marker information defines somewhat different polygonal shapes on the various layers of the circuit layout.

In a second step (step 202), segment layout information is extracted from the circuit layout by using the marker information. For example, in FIG. 5, marker information 126 is used to extract segment layout information for SEG A 123 from circuit layout 100. The marker information includes portions of each layer of the device.

In a third step (step 203), the extracted segment layout information is analyzed resulting in defect prediction information. The defect prediction information may be a Critical Area Analysis Index Value (CAAIV) or a yield prediction value. For example, in FIGS. 10 and 12, tables show the CAAIVs and yield prediction values for each layer of segment SEG A 123.

In a fourth step (step 204), the user decides to extract and analyze more segments, or to continue with comparing defect prediction information of the segments. For example, in FIG. 13 through FIG. 16, the user decides to include three more segments 145, 147 and 149 in the analysis. After the user has decided to include the segments sufficient for their analysis, the user can proceed to the step (step 205) of comparing the defect prediction information 151 of the segments. In step 205, defect prediction information 151 is compared for all the analyzed segments and the segment most susceptible to defects is identified. For example, in FIG. 17, the total yield prediction value for each segment is ranked in order of decreasing yield. Segment 145 is identified as the segment most susceptible to defects.

In a sixth step (step 206), the user decides whether to modify the design of a segment (or multiple segments). For example, if the results of the analysis and comparison of earlier steps show that segment 145 is very susceptible to defects, then the user may decide in step 206 to redesign the layout of segment 145 to improve the total yield prediction of the segment. On the other hand, if the results of the analysis and comparison of earlier steps show that all segments have acceptable total yield prediction values then the user may decide not to redesign segment 145 but rather to pass the design on for fabrication.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. In one specific example, a computer design tool 114 includes a segment information extractor and a segment analyzer. The segment information extractor includes a first portion of memory 118 that stores program 121 and processor 117 executing the set of processor-executable instructions of program 121. The segment analyzer includes a second portion of memory 118 that stores program 122 and processor 117 executing the set of processor-executable instructions of program 122. The programs 121 and 122 are sets of processor-executable instructions that are stored in the processor-readable medium 118.

Although certain specific embodiments are described above for instructional purposes, the teachings of this patent document have general applicability and are not limited to the specific embodiments described above. In one example, marker information is obtained by receiving specific coordinates from a user, where the coordinates define corners of a polygon that define a segment. In another example, marker information is obtained from polygons drawn by a user. Polygons are drawn by a user clicking a pointer on a display at locations that define coordinates of a segment. In another example, marker information is stored in an Open Artwork System Interchange Standard (OASIS) file. In another example, the marker information is obtained from a file, where the file includes the names of a series of nets, scan chains or cones. The computer design tool generates the marker information from the names of the nets, scan chains or cones. In another example, a computer design tool system obtains marker information for multiple segments from a user before performing any critical area analysis. In another example, a segment includes a plurality of nets, a plurality of scan chains, or a type of circuitry (such as memory), or any such combination. In one example, a segment includes many different separate circuits that are distributed across the integrated circuit. A segment may, for example, include all pieces of memory in an integrated circuit where there are several different arrays of memory on the integrated circuit and where those different arrays are disposed in different locations on the integrated circuit. In some examples a segment includes segment layout information defining portions of many layers of the overall circuit layout, whereas in other examples the segment layout information for each layer is considered to be a separate segment. Accordingly, various modifications, adaptations, and combinations of the various features of the described specific embodiments can be practiced without departing from the scope of the claims that are set forth below.

What is claimed is:

1. A method comprising:
(a) obtaining marker information that defines a segment of a circuit layout, wherein the circuit layout includes segment layout information corresponding to the segment and also includes other layout information;
(b) using the marker information to extract the segment layout information from the circuit layout; and
(c) analyzing the segment layout information and thereby determining defect prediction information.

2. The method of claim 1, further comprising:
(d) comparing the defect prediction information of the segment to a defect prediction information of another segment and thereby identifying a segment that is most susceptible to defects.

3. The method of claim 2, wherein the comparing of (d) involves ranking the defect prediction information of the segment and the defect prediction information of the other segment.

4. The method of claim 1, wherein the defect prediction information is taken from the group consisting of: a yield prediction value, a short critical area, an open critical area, and a Critical Area Analysis Index Value (CAAIV).

5. The method of claim 1, wherein the analyzing of step (c) involves performing a Critical Area Analysis (CAA) on the segment layout information thereby determining a Critical Area Analysis Index Value (CAAIV) for the segment.

6. The method of claim 1, wherein the marker information is a file taken from the group consisting of: a Graphic Data System (GDS) II file, and an Open Artwork System Interchange Standard (OASIS) file.

7. The method of claim 1, wherein the marker information includes a set of coordinates that defines a shape taken from the group consisting of: a polygon, and a circle.

8. The method of claim 1, wherein the obtaining of step (a) involves receiving user input, and generating marker information from the user input.

9. The method of claim 1, wherein the segment layout information includes layout information taken from the group consisting of: layout information that represents a scan chain, layout information that represents a net, layout information that represents a cone, layout information that represents a cell, and layout information that represents a block.

10. The method of claim 1, wherein the segment layout information includes layout information representing a portion of a first block of the circuit layout, and also includes layout information representing a portion of a second block of the circuit layout.

11. A system comprising:
a segment information extractor that receives marker information, wherein the marker information defines a segment of a circuit layout, and wherein the circuit layout includes segment layout information and other layout information, and wherein the segment information extractor also uses the marker information to extract the segment layout information from the circuit layout; and
a segment analyzer that determines defect prediction information of the segment layout information.

12. The system of claim 11, wherein the segment analyzer further compares the defect prediction information of the segment to a defect prediction information of another segment and thereby identifies a segment that is most susceptible to defects.

13. The system of claim 12, wherein the comparing involves ranking the defect prediction information of the segment and the defect prediction information of the other segment.

14. The system of claim 11, wherein the segment information extractor is a computer that is executing a segment information extractor program.

15. The system of claim 11, wherein the segment analyzer is a computer that is executing a segment analyzer program.

16. The system of claim 11, wherein the defect prediction information is taken from the group consisting of: a yield prediction value, a short critical area, an open critical area, and a Critical Area Analysis Index Value (CAAIV).

17. The system of claim 11, wherein the segment analyzer performs a Critical Area Analysis (CAA) on the segment thereby generating the defect prediction information.

18. The system of claim 11, wherein the marker information is a file taken from the group consisting of: a Graphic Data System (GDS) II file, and an Open Artwork System Interchange Standard (OASIS) file.

19. The system of claim 11, wherein the marker information includes a set of coordinates that defines a shape taken from the group consisting of: a polygon, and a circle.

20. The system of claim 11, wherein the segment information extractor is adapted to receive a circuit layout file and a marker information file, wherein the marker information file contains a set of coordinates corresponding to the segment, and wherein the segment information extractor extracts the segment layout information from the circuit layout file.

21. The system of claim 20, wherein the set of coordinates corresponding to the segment is supplied by a user.

22. The system of claim 11, wherein the segment layout information includes layout information representing a portion of a first block of the circuit layout, and also includes layout information representing a portion of a second block of the circuit layout.

23. A system comprising:
a storage medium for storing a circuit layout; and
means for extracting segment layout information from the circuit layout, wherein the segment layout information represents a segment of the circuit layout, and wherein the means is also for analyzing the segment layout information and thereby determining defect prediction information.

24. The system of claim 23, wherein the means is also for comparing the defect prediction information of the segment to a defect prediction information of another segment and thereby identifying a segment that is most susceptible to defects.

25. The system of claim 24, wherein the comparing involves ranking the defect prediction information of the segment and the defect prediction information of the other segment.

26. The system of claim 23, wherein the defect prediction information is taken from the group consisting of: a yield prediction value, a short critical area, an open critical area, and a Critical Area Analysis Index Value (CAAIV).

27. The system of claim 23, wherein the analyzing of the segment layout information involves performing a Critical Area Analysis (CAA) on the segment layout information thereby determining a Critical Area Analysis Index Value (CAAIV) for the segment.

28. The system of claim 23, wherein the segment layout information includes information representing a portion of a first block of the circuit layout, and also includes information representing a portion of a second block of the circuit layout.

29. The system of claim 23, wherein the system is a computer design tool, and wherein the means is a portion of the computer design tool that includes a processor and a portion of the storage medium.

30. A processor-readable medium storing a set of processor-executable instructions, wherein execution of the set of processor-executable instructions by a processor is for:
(a) obtaining marker information that defines a segment of a circuit layout, wherein the circuit layout includes segment layout information corresponding to the segment and also includes other layout information;
(b) using the marker information to extract the segment layout information from the circuit layout; and
(c) analyzing the segment layout information and thereby determining defect prediction information.

31. The processor-readable medium of claim 30, wherein execution of the set of processor-executable instructions is also for:
(d) comparing the defect prediction information of the segment to a defect prediction information of another segment and thereby identifying a segment that is most susceptible to defects.

32. The processor-readable medium of claim 31, wherein the comparing of (d) involves ranking the defect prediction information of the segment and the defect prediction information of the other segment.

33. The processor-readable medium of claim 30, wherein the defect prediction information is taken from the group consisting of: a yield prediction value, a short critical area, an open critical area, and a Critical Area Analysis Index Value (CAAIV).

34. The processor-readable medium of claim 30, wherein the analyzing of the segment layout information involves performing a Critical Area Analysis (CAA) on the segment layout information thereby determining a Critical Area Analysis Index Value (CAAIV) for the segment.

35. The processor-readable medium of claim 30, wherein the segment layout information includes information representing a portion of a first block of the circuit layout, and also includes information representing a portion of a second block of the circuit layout.

36. The processor-readable medium of claim 30, wherein the processor-readable medium is taken from the group consisting of: a semiconductor memory, an optical disc, a magnetic storage device, and a non-volatile memory device.
